(19) United States
(12) Patent Application Publication
(10) Pub. No.: US 2015/0189895 A1
(43) Pub. Date: Jul. 9, 2015

(54) Compositions Comprising High-Protein Yogurt Powders and Methods for Making Them

(71) Applicants: Earl Christiansen, Twin Falls, ID (US); Loren S. Ward, Twin Falls, ID (US)

(72) Inventors: Earl Christiansen, Twin Falls, ID (US); Loren S. Ward, Twin Falls, ID (US)

(21) Appl. No.: 14/592,376

(22) Filed: Jan. 8, 2015

Related U.S. Application Data
(60) Provisional application No. 61/925,212, filed on Jan. 8, 2014.

(51) Int. Cl. A23C 9/123

(52) U.S. Cl. CPC A23C 9/1232

(57) ABSTRACT

Disclosed is a method for producing high-protein yogurt powders, which may have application as ingredients in nutritional bars, coatings, cereals, sauces, ready-to-mix applications, instant beverages, and bakery applications.

### FIELD OF THE INVENTION

The invention relates to compositions comprising dairy powders, and more specifically, high-protein yogurt powders with improved sensory properties.

### BACKGROUND OF THE INVENTION

The desirable taste and nutritional characteristics of yogurt have catapulted the yogurt market to over four billion U.S. Dollars annually. With the development of the Greek yogurt product market, consumers have become more interested in higher-protein yogurt products, as well as products with milder yogurt taste.

Yogurts are prepared by fermentation of milk with bacterial cultures consisting of a mixture of Streptococcus subsp. thermophilus and Lactobacillus delbrueckiisubsp. Bulgaricus, or other comparable cultures. Manufacture of yogurt usually involves milk fortification with dairy ingredients to increase the concentration of protein to 40-50 g/kg. Polysaccharides and stabilizers are sometimes added to improve texture. The fortified milk is homogenized, heated, cooled to the desired fermentation temperature, and inoculated with starter cultures. For “set yogurt,” the inoculated milk is filled into cups and incubated to the desired pH (usually about 4.5-4.7), then cooled to 40° F. without disturbing the curd. In the case of stirred yogurt, the inoculated milk is filled into a tank where the fermentation occurs. After fermentation, the gel is broken by stirring or other agitation, and the yogurt is pumped through a fine mesh, cooled, and packaged into cups.

Although yogurt possesses many desirable qualities, extended shelf-life is not one of them. While fresh yogurt requires refrigeration and has a limited shelf life, yogurt powders are stable at ambient temperature for a year or more if properly stored. Yogurt can be dried by spray-drying, microwaving, convective drying, freeze-drying, etc. Yogurt powder is very high in calcium, carbohydrates, sugars and proteins, and is also a rich source of vitamin A. Yogurt powders add a unique flavor to various types of food products, including beverages, confections, breakfast cereals, dairy products such as ice creams, baby foods, soups, and dips. They may be used in place of fresh yogurt and are frequently used in the manufacture of confectionery coatings for pretzels, dried fruit, cereal and other snack food products. Yogurt powders have also been used in cat food, dog food, toothpaste, mouthwash, and cosmetics. Yogurt powders may be applied topically as a coating for cereals and snacks, or may be blended into a variety of beverages. Yogurt powders may be incorporated into products in their dry powder form, or may be reconstituted for use as an ingredient or to produce an edible yogurt composition. Desirable attributes of reconstituted yogurt therefore include viscosity and cohesiveness.

The milk solids content of yogurt ranges from about 8 percent for skim milk yogurt to at least 20 percent for concentrated yogurt (fortified). Commercial yogurt products generally have milk solids contents of about 10 to 15 percent. The protein content of currently marketed yogurt powders is about 33-36 percent. It would be desirable to increase the protein content in yogurt powder, but doing so currently introduces additional challenges into the drying process. For example, while yogurt is a viscous composition, in itself—and higher-protein yogurt such as Greek yogurt is even more so—the addition of just 1, 2, or 3 percent skim milk powder has been found to increase yogurt viscosity by 22, 43 and 70 percent, respectively (Rohm, H., Influence of Dry Matter Fortification on Flow Properties of Yogurt. 2. Time-dependent Behavior. Milchwissenschaft (1993) 48: 614-617). Higher solids levels may also produce a powdery taste that is undesirable to consumers.

What are needed are effective methods for producing higher-protein yogurt powders with desirable sensory properties and methods for increasing drying efficiency of high solids material.

### SUMMARY OF THE INVENTION

The invention relates to a yogurt powder composition comprising at least about 40% protein. In other aspects, the invention also relates to a method for making a yogurt powder composition comprising at least about 40% protein, the method comprising preparing a yogurt composition by admixing a first component selected from the group consisting of skim milk, low-fat milk, reduced-fat milk, whole milk, hydrated dry milk powder, and combinations thereof, and a second component comprising a solids composition selected from the group consisting of milk protein concentrate (MPC), whey protein concentrate (WPC), nonfat dry milk (NFDM), and combinations thereof, the second component comprising from about 2% to about 10% by weight of the yogurt composition, culturing the yogurt composition with agitation to produce a yogurt composition of about pH 4.5-4.7, and drying the yogurt composition.

In various aspects, the agitation may comprise shaking, stirring, or other methods that would generate shear and decrease viscosity during fermentation.

Aspects of the invention comprising yogurt powders of at least about 40% protein may also include compositions comprising at least about 41 percent protein, at least about 42 percent protein, at least about 45 percent protein, at least about 50 percent protein, etc., for example, as well as a range of from about 40% to about 80% and sub-ranges thereof.

### BRIEF DESCRIPTION OF THE DRAWINGS

FIG. 1 is a schematic diagram that illustrates an example of a method for producing a yogurt powder as described by the invention.

FIG. 2 is a graph illustrating the difference in viscosity between agitated and non-agitated products of similar composition and fermentation parameters.

### DETAILED DESCRIPTION

Drying dairy powders requires taking into account the unique proteins found in dairy products, as well as their interactions. Yogurt, particularly, is a viscous composition, generally becoming significantly more viscous with the addition of protein-containing solids. For example, many consider the addition of more than 2 percent whey protein to induce some undesirable sensory properties in yogurt, and higher solids levels may produce a powdery taste that is undesirable to consumers. Yogurt powders must be formulated to take these concerns into account. The inventors have developed a method for producing yogurt powders having higher protein content (e.g., at least about 40 percent protein by weight), as well as a pleasant taste with desirable yogurt flavors and odors produced during fermentation. The inventors have discovered that agitating yogurt during the fermentation process provides a method by which more protein may be incorporated into a yogurt product that, when dried, can have a higher protein content as well as a smoother mouthfeel for such a higher protein product.

Spray-drying provides an effective method for producing yogurt powder. Spray-drying methods, however, often result in agglomeration of the powder along the sides of the dryer, the potential for burning of the agglomerated powder, and caking that may cause the powder to degrade more quickly. A particularly important parameter in spray-drying is the feed flow rate, which can be more difficult to control with highly viscous compositions. The inventors were therefore faced with solving the problem of how to decrease the viscosity of a cultured yogurt product to which additional solids have been added. Aguirre-Ezkauriatza et. al. noted that stirring during yogurt culture could reduce its viscosity (Aguirre-Ezkauriatza, E. J. et. al., Effect of Mixing During Fermentation in Yogurt Manufacturing, J. Dairy Sci. (2008) 91:4454-4465). However, the addition of protein-rich compositions such as milk protein concentrate (MPC) or whey protein concentrate (WPC) may increase the viscosity of yogurt by 30 to 500 percent. For example, Rohm reported that the addition of as little as three percent skim milk powder could increase yogurt viscosity by 70 percent (Rohm, H., Influence of Dry Matter Fortification on Flow Properties of Yogurt. 2. Time-dependent Behavior. Milchwissenschaft (1993) 48: 614-617). As Lee and Lucey observed, “[t]he physical and sensory properties of yogurt gels are greatly influenced by the total solids content of the yogurt milk, especially the protein content” (W. J. Lee and J. A. Lucey, Formation and Physical Properties of Yogurt, Asian-Aust. J. Anim. Sci. (September 2010) Vol. 23, No. 9: 1127-1136). Therefore, when additional solids are added to yogurt, viscosity reaches a level that can seriously impact the flow rate of fermented yogurt product to a dryer, making it more difficult to consistently produce a powder with the desired taste, particle size, consistency, color, and other properties associated with commercial yogurt powders.

The inventors have discovered that maintaining enough agitation of the culture vessel to keep the culture blend moving can produce a sufficient decrease in viscosity to achieve a desirable feed flow rate for spray-drying, as well as to produce a dried yogurt powder having a desirable and pleasant yogurt taste. As used herein, the term “culturing the skim milk and solids composition with agitation” is intended to mean either continuous or intermittent agitation during fermentation. The goal of continuous or intermittent agitation during fermentation is to provide enough agitation/shear to prevent to prevent formation of a gel matrix. Given the disclosure provided herein, it would be within the scope of skill of one of skill in the art to modify agitation methods and/or agitation timing to provide sufficient shear to produce a higher solids/lower viscosity product for drying.

The invention provides a yogurt powder composition comprising at least about 40% protein, as well as a method for making a yogurt powder composition comprising at least about 40% protein, the method comprising preparing a yogurt composition by admixing a first component selected from the group consisting of skim milk, low-fat milk, reduced-fat milk, whole milk, hydrated dry milk powder, and combinations thereof, and a second component comprising a solids composition selected from the group consisting of milk protein concentrate (MPC), whey protein concentrate (WPC), nonfat dry milk (NFDM), and combinations thereof, the second component comprising from about 2% to about 10% by weight of the yogurt composition, culturing the yogurt composition with agitation to produce a yogurt composition of about pH 4.5-4.7, and drying the yogurt composition. Ultimately, the admixture of the first component and the second component should be liquid, but this may be accomplished either by starting with a first component that is a liquid, starting with a first component comprising dry solids that have been hydrated, or admixing dry first and second components, and hydrating the admixture.

Yogurt powders made by the method of the invention may produce high-yield, high-protein, low-moisture products that are suitable for use as an ingredients in nutritional bars, coatings, cereals, sauces, ready-to-mix applications, instant beverages, and bakery applications. Briefly, protein-containing powders such as dry MPC and WPC powder may be added to liquid skim milk, commonly used to produce yogurt, to provide a 14-20 percent solids content. The proteins are hydrated and the liquid composition is pasteurized, then cooled to from about 180 to about 110 degrees Fahrenheit before it is pumped to a fermentation tank. The skim milk/added solids admixture is inoculated with suitable bacterial culture to produce a product having the standard of identity of dairy yogurt, and fermentation is promoted by holding at a temperature of from about 100° F. to about 110° F. with stirring, external agitation of the tank, or other means for promoting movement of the skim milk/added solids admixture and bacterial culture during fermentation. When the pH of the admixture reaches from about 4.7 to about 4.5 (generally after about 6-8 hours at a temperature of from about 105° F. to about 112° F.), the fermented admixture, now a yogurt product, is cooled to a temperature of from about 110° F. to about 45° F. Once cooled, the yogurt product is pumped to a drier (e.g., a spray drier) and dried at a temperature of from about 80° C. to about 90° C. outlet temperature. The resulting powder may then be packaged into appropriate packaging, such as 20 kg bag.

Where the term “comprising” is used herein, it should be understood that “consisting of” or “consisting essentially of” may be substituted for the term “comprising.” “Yogurt powder” and “powdered yogurt” may be used interchangeably herein. The invention may be further described by means of the following non-limiting examples.

### EXAMPLES

Dry MPC and WPC powder were added to liquid skim milk to provide 14-20 percent solids, which were allowed to hydrate for about 15 minutes. The liquid composition was heated to pasteurize for 6 minutes at 190 degrees Fahrenheit, then cooled to 110 degrees Fahrenheit before pumping to a fermentation tank. After inoculating the MPC/WPC/liquid skim milk with appropriate yogurt culture strains, the product was held for 4-6 hours at 110F degrees Fahrenheit with sufficient agitation to keep the MPC/WPC/liquid skim milk blend moving (i.e., to achieve a stirring effect). When the mixture reached a pH of approximately 4.7, it was cooled to a temperature of about 40 degrees Fahrenheit, slowly stirred until smooth, and pumped to the dryer. Dry product yield was about 98 percent, giving a yogurt powder having a protein content of about 55 to about 65 percent and a moisture content of about 4 to about 5 percent.

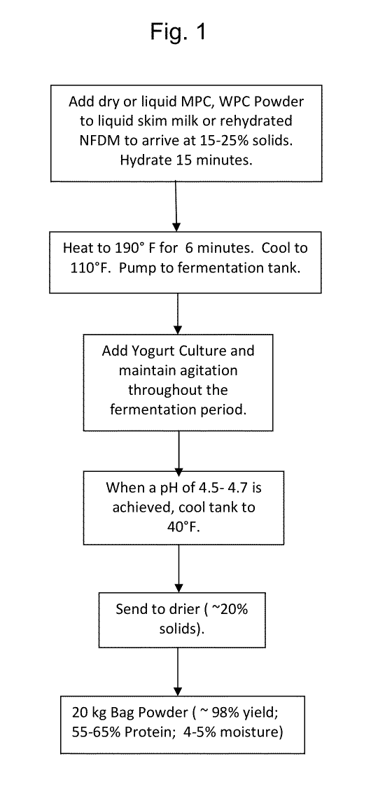

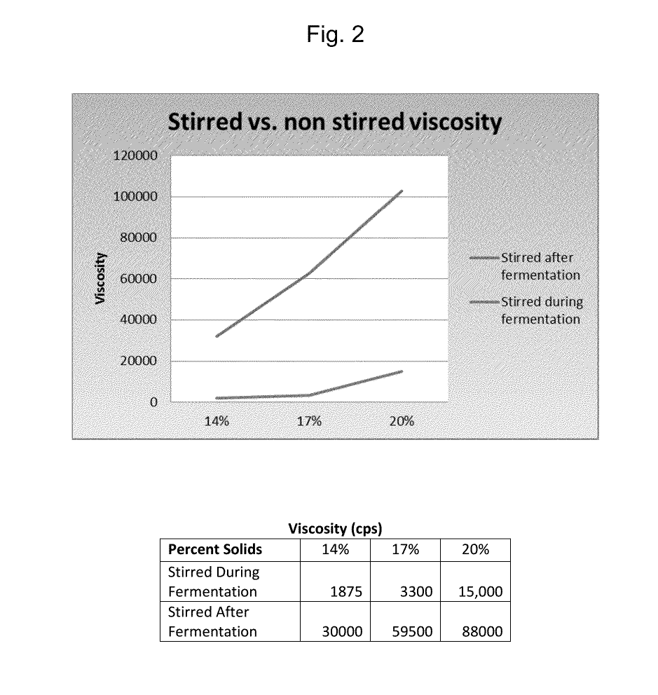

FIG. 1 illustrates the method of the invention, and FIG. 2 is a graph illustrating the difference in viscosity between stirred and non-stirred products of similar composition and fermentation parameters.

What is claimed is:

1. A yogurt powder composition comprising at least about 40% protein.

2. A method for making a yogurt powder composition comprising at least about 40% protein, the method comprising method comprising:
a) preparing a yogurt composition by admixing a first component selected from the group consisting of skim milk, low-fat milk, reduced-fat milk, whole milk, hydrated dry milk powder, and combinations thereof, and a second component comprising a solids composition selected from the group consisting of milk protein concentrate (MPC), whey protein concentrate (WPC), nonfat dry milk (NFDM), and combinations thereof, the second component comprising from about 2% to about 10% by weight of the yogurt composition;
b) culturing the yogurt composition with agitation to produce a yogurt composition of about pH 4.5-4.7; and
c) drying the yogurt composition.

3. The method of claim 2 wherein the agitation may comprise shaking, stirring, pumping, or combinations thereof.

4. The method of claim 2 wherein the drying is done using a spray dryer.
